(19) United States
(12) Patent Application Publication
(10) Pub. No.: US 2018/0199162 A1
(43) Pub. Date: Jul. 12, 2018

(54) SELF-LOCATION ESTIMATION APPARATUS AND SELF-LOCATION ESTIMATION METHOD

(71) Applicant: Kabushiki Kaisha Toshiba, Tokyo (JP)

(72) Inventors: Daisuke YAMAMOTO, Kawasaki Kanagawa (JP); Takafumi SONOURA, Yokohama Kanagawa (JP)

(73) Assignee: Kabushiki Kaisha Toshiba, Tokyo (JP)

(21) Appl. No.: 15/691,619

(22) Filed: Aug. 30, 2017

(30) Foreign Application Priority Data
Jan. 10, 2017 (JP) 2017-002001

(51) Int. Cl. H04W 4/04; G01S 17/89; G01S 17/93; G01S 19/07

(52) U.S. Cl. CPC H04W 4/046; G01S 17/89; G01S 19/07; H04W 4/043; G01S 17/936

(57) ABSTRACT

A self-location estimation apparatus and a self-location estimation method which can more accurately estimate a self-location are provided. A self-location estimation apparatus according to an embodiment is installable at a cart which is movable on the basis of an environment map. The self-location estimation apparatus according to the embodiment includes a distance sensor device configured to measure a distance thereof from an object, an angle sensor device configured to measure a measurement range of the distance sensor device, which fluctuates due to rocking along with movement of the cart, and an estimation device configured to estimate a self-location on the basis of a position of a mark installed at the environment and which is identified using the environment map, the distance, intensity of reflected light, and the measurement range.

### CROSS-REFERENCE TO RELATED APPLICATION

This application is based upon and claims the benefit of priority from the prior Japanese Patent Application No. 2017-002001, filed on Jan. 10, 2017, the entire contents of which are incorporated herein by reference.

### FIELD

Embodiments described herein relate generally to a self-location estimation apparatus and a self-location estimation method.

### BACKGROUND

In recent years, studies on utilizing mobile robots, such as unmanned carrier automatic guided vehicles (AGVs) used in factories, for the purpose of shelf inventory management, infrastructure inspection, and the like at shops are underway. In order to accurately move such mobile robots along predetermined travel routes, the mobile robots need to accurately measure self-locations.

Examples of a method of measuring a self-location include methods of measuring self-locations when unmanned carriers detect magnetic tapes laid on floors such that such unmanned carriers move along the detected magnetic tapes. Furthermore, example of methods in which no magnetic tape is used include methods of simultaneously performing self-location estimation, which is referred to as simultaneous localization and mapping (SLAM), and environment map creation.

In SLAM, surrounding environments are measured using two-dimensional distance sensors such as a laser range finder (LRF), three-dimensional distance sensors such as light detection and ranging (LiDAR), three-dimensional measurement using cameras, or the like, and unmanned carriers create environment maps while traveling. Moreover, self-locations are estimated on the basis of the measured surrounding environments and environment maps. Recently, particularly, in factories, mobile robots using SLAM using two-dimensional distance sensors (for example, AGVs) are spreading. However, in the case of SLAM, estimation accuracy of self-locations is lowered in some cases when there are few features in environments (for example, cases of environments like wide gyms and environments in which monotonous corridors continue) and when environments change.

In order to cope with such environments in which estimation accuracy of self-locations is lowered, characteristic objects (hereinafter also referred to as “markers”) serving as marks which are used for estimating self-locations are installed in the environments in some cases. For example, markers using retroreflection members are installed in environments, and such positions of markers are measured using laser range finders. Laser range finders measure phase differences between irradiated light and reflected light and a time until the reflected light is received to measure distances from positions of the laser range finders themselves to surrounding objects. The retroreflection members are members configured to linearly reflect incident light in a direction of a light source (that is, in which an angle of incidence and an angle of outgoing are equal). Generally, reflectivity of the retroreflection members are higher than those of other objects in the environment in many cases. Thus, the markers and other surrounding objects can be identified on the basis of differences between intensities of reflected light of general objects according to distances measured by the laser range finder, and intensity of reflected light of the retroreflection member.

However, there are objects (for example, a pole made of a metal, a cylindrical pillar of a shelf, and the like) other than a marker which has the same reflectivity as the retroreflection member (in which an angle of incidence and an angle of outgoing are the same and reflectance thereof is high) in an environment in some cases. In this case, a laser range finder may erroneously determine that the object, which is not the marker, is a marker in some cases, and thus there is a problem regarding a decrease in estimation accuracy of a self-location of a mobile robot.

### BRIEF DESCRIPTION OF THE DRAWINGS

FIG. 1 is a diagram showing an overview of shelf inventory management using a mobile robot according to a first embodiment.

FIG. 2 is a diagram showing a constitution associated with detecting a marker using the mobile robot according to the first embodiment.

FIG. 3 is a diagram illustrating an example of a measurement range of the marker using the mobile robot according to the first embodiment.

FIG. 4 is a diagram illustrating an example of a relationship between a measurement range and a variation width of a measurement place.

FIG. 5 is a diagram illustrating an example of detecting a marker using the mobile robot according to the first embodiment.

FIG. 6 is a block diagram showing a functional constitution of the mobile robot according to the first embodiment.

FIG. 7 is a flowchart for describing an operation of a self-location estimation apparatus of the mobile robot according to the first embodiment.

FIG. 8 is a diagram illustrating an example detecting a marker using a mobile robot according to a second embodiment.

FIG. 9 is a diagram illustrating an example of a marker detected by a mobile robot according to a third embodiment.

FIG. 10 is a diagram illustrating an example of a marker detected by a mobile robot according to a fourth embodiment.

FIG. 11 is a diagram illustrating an example of a marker detected by a mobile robot according to a fifth embodiment.

FIG. 12 is a flowchart for describing operation of a self-location estimation apparatus of the mobile robot according to the fifth embodiment.

FIG. 13 is a diagram showing an overview of a device inspection using a mobile robot according to a sixth embodiment.

### DETAILED DESCRIPTION OF THE INVENTION

A self-location estimation apparatus according to an embodiment is installable at a cart which is movable on the basis of an environment map. The self-location estimation apparatus according to the embodiment includes a distance sensor device configured to measure a distance thereof from an object, an angle sensor device configured to measure a detection range of the distance sensor device, which fluctuates due to rocking along with movement of the cart, and a self-location estimation device configured to estimate a self-location on the basis of a position of a mark installed on the environment and which is identified using the environment map, the distance, intensity of the reflected light, and the detected range.

A self-location estimation apparatus and a self-location estimation method according to an embodiment will be described below with reference to the drawings.

A self-location estimation apparatus according to first to fifth embodiments, which will be described below, is a device mounted in a mobile robot configured to perform shelf inventory management in a store.

### First Embodiment

The first embodiment will be described below with reference to the drawings.

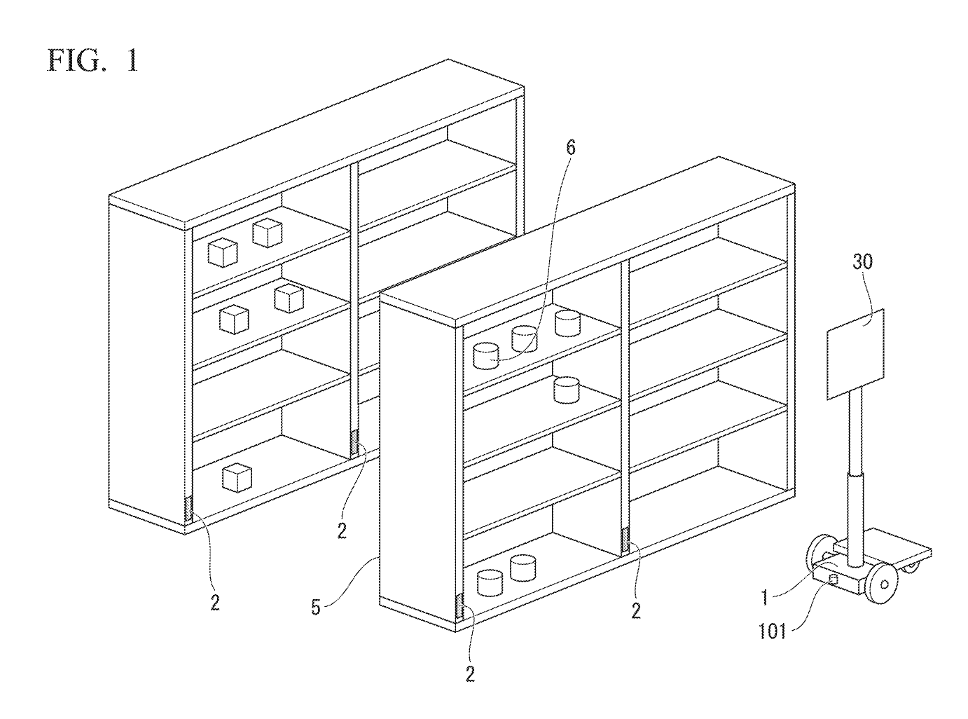

FIG. 1 is a diagram showing an overview of shelf inventory management using a mobile robot according to the first embodiment. A self-propelled mobile robot 1 and a plurality of commodity shelves 5 present in an environment (a store) shown in FIG. 1. Commodities 6 are stored on the commodity shelves 5, and markers 2 are installed on lower portions of pillars (or lateral plates) of the commodity shelves 5.

The mobile robot 1 includes a self-location estimation apparatus 10 (not shown) including a sensor device 101 and an inventory management device 30.

The mobile robot 1 travels in front of one of the commodity shelves 5 and checks inventory of the commodities 6 stored in each of the commodity shelves 5 using the inventory management device 30. To be specific, the inventory management device 30 includes an inventory detection device 301 including a wireless tag reader which will be described below. Thus, the inventory management device 30 can detect wireless tags (not shown) stuck to the commodities 6 using the inventory detection device 301 to check the inventory thereof.

Note that a constitution configured to check inventory is not limited to the above-described constitution. In the constitution configured to check inventory, for example, the inventory management device 30 may be constituted such that each of the commodity shelves 5 is imaged using a camera (not shown) included in the inventory management device 30, the captured image is analyzed, and thus the inventory is checked.

Also, the sensor device 101 includes a distance sensor device 1011 including a laser range finder (LRF), which will be described below. The laser range finder of the distance sensor device 1011 irradiates objects near the distance sensor device 1011 with a laser and receives reflected light when the laser hits the objects near the distance sensor device 1011 and is reflected therefrom. Moreover, the laser range finder of the distance sensor device 1011 measures a distance between the laser range finder and the object on the basis of a phase difference between the irradiated light and the reflected light and a time until the reflected light is received after the laser is radiated.

The object, toward which the laser radiated by the laser range finder of the distance sensor device 1011, is the marker 2 stuck to the commodity shelve 5 in some cases.

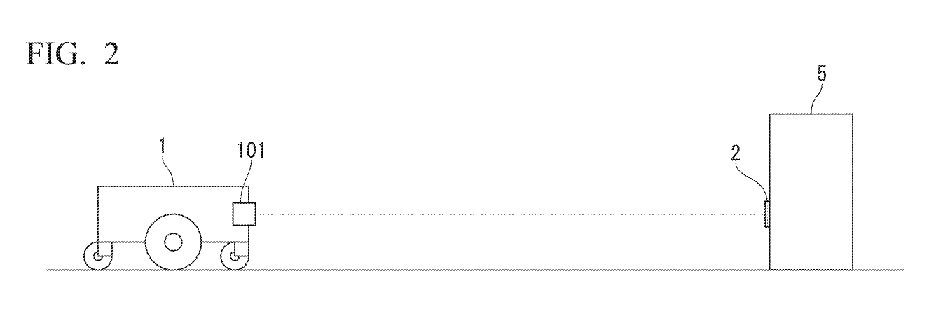

FIG. 2 is a diagram showing a constitution associated with detecting a marker using the mobile robot according to the first embodiment. As shown in FIG. 2, a laser radiated from the laser range finder (not shown) included in the sensor device 101 in the mobile robot 1 hits the marker 2 installed at (stuck to) the commodity shelve 5 and is reflected therefrom. Moreover, the laser range finder receives the reflected light once so that the laser range finder can measure a distance between the laser range finder and the marker.

A retroreflection member used for the marker 2 is, for example, a sheet-like member coated with glass beads. A retroreflection member on a plane coated with glass beads depends on specific details of other objects near the retroreflection member in the environment. Here, generally, the retroreflection member has reflectivity when an angle of incidence is approximately 65° or less, and reflectance thereof is relatively higher than reflectance of the other objects near the retroreflection member. Thus, the self-location estimation apparatus 10 mounted in the mobile robot 1 can determine the marker 2 from the other objects.

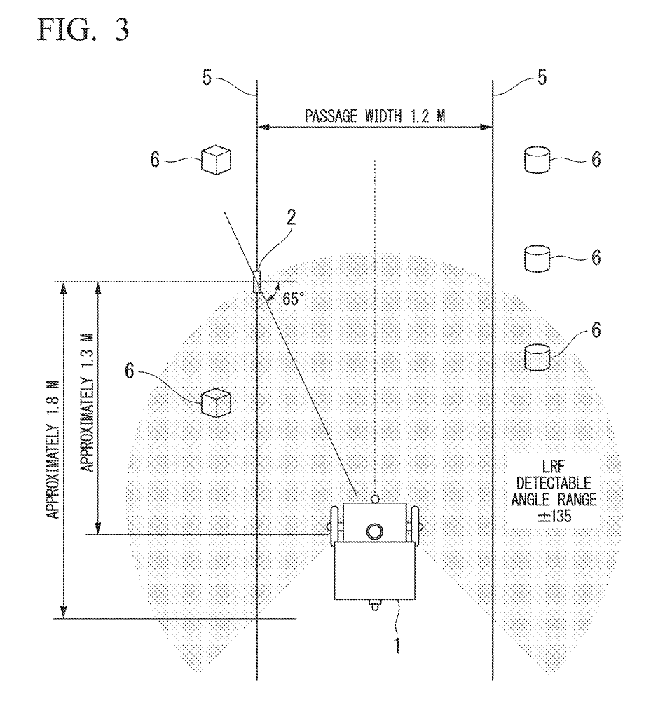

FIG. 3 is a diagram illustrating an example of a measurement range of the marker by the mobile robot according to the first embodiment.

A detectable angle range when the laser range finder (LRF) included in the mobile robot 1 detects an object near the laser range finder exemplified in FIG. 3 is ±135°. Furthermore, an angle of incidence of a retroreflection member of the marker 2 exemplified in FIG. 3 is 65°. A passage width of a passage surrounded by the commodity shelves 5 along which the mobile robot 1 moves exemplified in FIG. 3 is 1.2 meters, and it is assumed that the mobile robot travels along the center of the passage.

In this case, the laser range finder included in the mobile robot 1 can detect the marker 2 installed at the commodity shelf 5 up to a position laser range finder which is approximately 1.3 meters in front of the position of the laser range finder. Furthermore, the laser range finder can detect a marker 2 installed at a commodity shelf 5 at any site within a total of 1.8 meters in front of and behind the position of the laser range finder (that is, any site between a site which is approximately 1.3 meters in front of the position of the laser range finder and a site which is approximately 0.5 meters behind of the position of the laser range finder).

The self-location estimation apparatus 10 in the mobile robot 1 measures a distance between the laser range finder and objects which are present above a measurement surface of the laser range finder such as a commodity shelf 5 near the laser range finder and the commodity 6 stored in the commodity shelf 5 using the distance sensor device 1011 including the laser range finder. Moreover, the self-location estimation apparatus 10 creates and updates an environment map on the basis of the measured result. The self-location estimation apparatus 10 in the mobile robot 1 collates the created and updated environment map and a currently measured environment around the mobile robot 1 while the mobile robot 1 is travelling. The self-location estimation apparatus 10 estimates a current self-location in the environment map on the basis of the collated result. The self-location estimation apparatus 10 further updates the environment map on the basis of the estimated self-location and the surrounding environment. The above-described operation is repeatedly performed so that the self-location estimation apparatus 10 can improve accuracy of the environment map and estimation accuracy of the self-location.

In the shelf inventory management, the mobile robot 1 first travels to create the environment map. The mobile robot 1 travels on a passage in front of the commodity shelf 5 in which the commodity 6, which needs to have inventory checked, is stored along a predetermined travel route. Moreover, the self-location estimation apparatus 10 in the mobile robot 1 performs creation of an environment map and estimation of a self-location on the basis of a surrounding environment measured while the mobile robot 1 is traveling.

Also, the mobile robot 1 travels along a travel route set in an environment map when traveling to check inventory of the commodities 6 stored in the commodity shelf 5. The self-location estimation apparatus 10 in the mobile robot 1 estimates a self-location on the basis of the created environment map and the measured surrounding environment as described above. The self-location estimation apparatus 10 controls movement of the mobile robot 1 so that its own mobile robot 1 travels along the travel route when the estimated position is shifted from a designated travel route in the environment map. The self-location estimation apparatus 10 reflects location information in the measured surrounding environment (object) in the environment map even at a time of traveling each time the inventory of the commodities 6 stored in the commodity shelves 5 is checked and improves accuracy of the environment map.

For example, when the commodities 6 above the measurement surface of the laser range finder are removed from the commodity shelf 5 and the like, an environment in which measurement is performed using the laser range finder may be changed in some cases. In this case, a difference occurs between the environment map and the measured surrounding environment. Thus, there are problems regarding estimation accuracy of the self-location being lowered and the mobile robot 1 being unable to travel along the travel route designated in the environment map in some cases.

Also, as described above, the self-location estimation apparatus 10 estimates, as a self-location, a position at which the self-location estimation apparatus 10 itself is highly likely to be estimated as being present in the environment map. In this way, the self-location estimation apparatus 10 probabilistically estimates a self-location on the basis of results of a measurement performed on the environment several times in the past.

For this reason, the mobile robot 1 can travel if there is some change in an environment, but estimation accuracy of a self-location is lowered in some cases. There is a problem regarding the fact that estimation accuracy is lowered and thus, for example, a distance between the mobile robot 1 and the commodity shelf 5 to be checked is too far so that the mobile robot 1 cannot check the commodity shelf 5 in some cases. This is because a distance over which the above-described wireless tag reader in the inventory detection device 301 in the inventory management device 30 can detect a wireless tag stuck to a commodity 6 is shorter than, for example, a distance over which the laser range finder can detect a marker 2, and the like.

Also, even when there is no change in the environment, if there is no object with a characteristic shape in the environment (for example, a case in which an environment in which a certain wall continues and the like), since it is difficult to specify a position of the object when the environment map and the measured surrounding environment are collated, a problem regarding an error in estimating a self-location easily occurs.

In order to solve the above-described problems, in this embodiment, markers 2 for which the above-described retroreflection member is used are installed at places in an environment. The self-location estimation apparatus 10 registers a measured surrounding environment and the detected marker 2 in the environment map when the environment map is created.

Generally, a suspension by which a mobile robot is vertically rocked is provided, for example, in a mobile robot such as an unmanned carrier used in a factory in many cases such that the mobile robot can travel over a step and the like in a floor surface. If the mobile robot is vertically rocked by the suspension, a measurement surface of a laser range finder installed at the mobile robot is also varied vertically.

The mobile robot 1 in this embodiment also includes a suspension 201, which will be described below, configured to vertically rock to be able to travel over a step in a floor surface, a laid cable, and the like in an environment. For this reason, when the mobile robot 1 travels, a measurement range of the laser range finder included in the mobile robot 1 is changed, and the measurement surface is varied vertically.

Generally, the measurement range of the laser range finder is changed in at least a range of about ±0.5° using the suspension 201 included in the mobile robot 1 in many cases. Particularly, a measurement range of the laser range finder is changed in the range of about ±5°, for example, at a place which is not even (is uneven) compared with a floor surface in a factory, like a floor surface in a store, an outdoor ground, and the like.

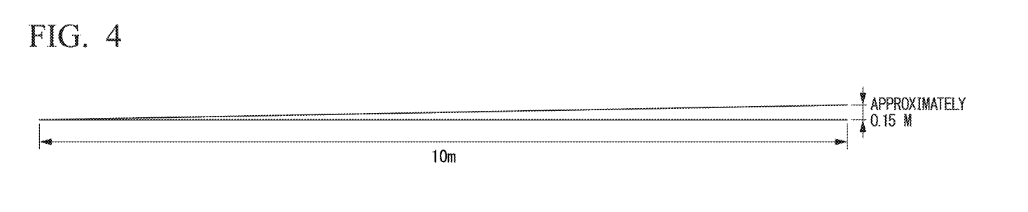

FIG. 4 is a diagram illustrating an example of a relationship between a measurement range and a variation width of a measurement place.

As shown in FIG. 4, when a variable range of the measurement range of the laser range finder is ±0.5°, a variation width of the measurement place is about ±0.15 meters at a site which is 10 meters in front of the laser range finder.

With regard to an object with a high height, such as a shelf, a pillar, and a wall, in an environment, the laser range finder can recognize the object even when a variation width of a measurement place is about ±0.15 meters. However, it is desirable that the marker 2 to be installed is as small as possible (with no height) in many cases. This is because the marker 2 acts as an obstacle at a time of, for example, selling the commodity 6 in a store and the like if the marker 2 is large.

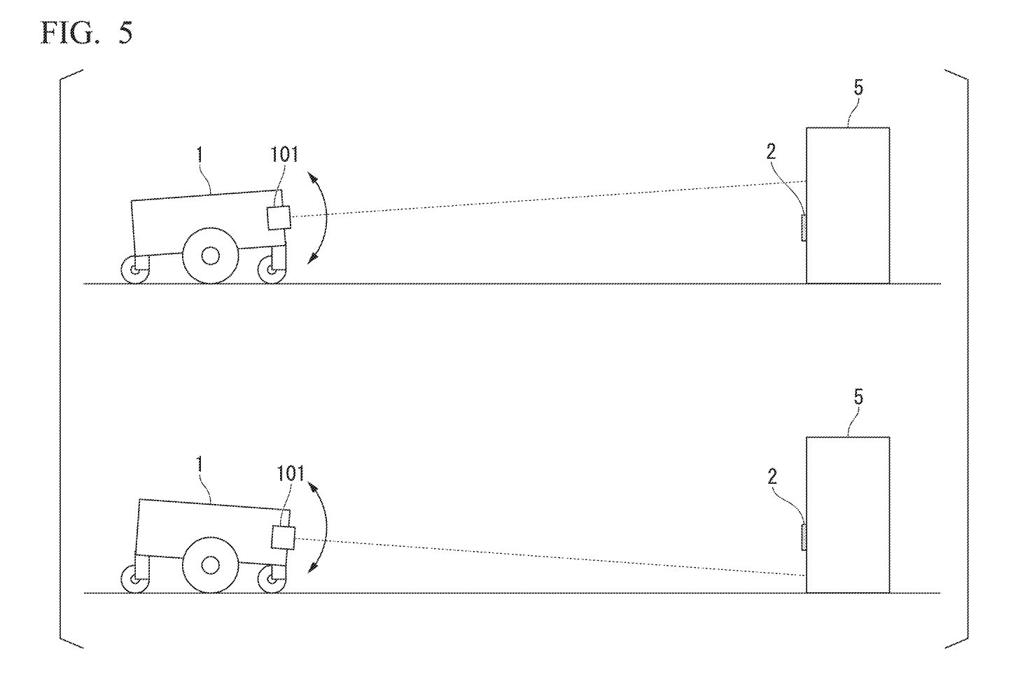

FIG. 5 is a diagram illustrating an example of detecting a marker using the mobile robot according to the first embodiment. As shown in FIG. 5, when a variation width of a measurement place exceeds a height (a vertical height) of the marker 2, the laser range finder cannot recognize the marker 2 in some cases. Since the variation width of the measurement place at a site which is 10 meters away from the laser range finder is about ±0.15 meters as described above, for example, when a height (a vertical height) of the marker 2 is 0.2 meters, the laser range finder cannot recognize the marker 2 in some cases. In this case, no location information of the marker 2 is registered in an environment map.

The self-location estimation apparatus 10 according to this embodiment includes an angle sensor device 1012, which will be described below, configured to measure the measurement range of the laser range finder. The angle sensor device 1012 is constituted to include a three-axis acceleration sensor (not shown) and a three-axis angular acceleration sensor (for example, a gyro; not shown). The angle sensor device 1012 detects a gravity direction using the three-axis angular acceleration sensor when its own mobile robot 1 stops and measures the measurement range of the laser range finder using the three-axis angular acceleration sensor when its own mobile robot 1 travels.

Note that, although the angle sensor device 1012 is constituted to include the three-axis acceleration sensor and the three-axis angular acceleration sensor in this embodiment, the present invention is not limited thereto. The angle sensor device 1012 may be constituted to cancel acceleration when its own mobile robot 1 travels, for example, using the three-axis acceleration sensor and a wheel rotation speed sensor and to measure the measurement range of the laser range finder. The angle sensor device 1012 may have any constitution as long as the angle sensor device 1012 can measure the measurement range of the laser range finder.

The self-location estimation apparatus 10 registers information of the detected marker 2 in the environment map on the basis of a distance between its own mobile robot 1 and the marker 2 and the measurement range of the laser range finder from its own mobile robot 1 toward the marker 2. The information registered in the environment map includes information indicating a position of the marker 2 above a plane in the environment as well as a position thereof in a height direction.

To be specific, when the measurement range of the laser range finder measured by the angle sensor device 1012 has an angle within a certain range, the laser range finder detects the marker 2. When the measurement range thereof has an angle outside of the certain range, since a laser radiated by the laser range finder does not hit the marker 2, no marker 2 is detected. The self-location estimation apparatus 10 can estimate a top position and a bottom position of the marker 2 on the basis of an upper limit and a lower limit of the measurement range of the laser range finder when the marker 2 is detected.

The self-location estimation apparatus 10 estimates the position of the marker 2 in consideration of both the distance between its own mobile robot 1 and the marker 2 measured by the laser range finder and the measurement range of the laser range finder measured by the angle sensor device 1012. Thus, the self-location estimation apparatus 10 can estimate the position of the marker 2 as well as the position thereof in the height direction, and can register location information including location information of the marker 2 in the height direction in the environment map.

The self-location estimation apparatus 10 travels in a repetitive environment, repetitive markers 2 are detected, positions of the markers 2 are repeatedly measured, and location information of each of the markers 2 in an environment map is updated. Thus, estimation accuracy of location information indicating an installation position of the marker 2 and including a position in a height direction is improved.

Note that accuracy of the detection of the marker 2 using the self-location estimation apparatus 10 can be further improved as long as information indicating an actual position of the installed marker 2 in the height direction can be registered in the environment map in advance (for example, through a manual input or the like).

In this way, the self-location estimation apparatus 10 can estimate the position of the marker 2 in the height direction (for example, top and bottom positions of the marker 2) using the angle sensor device 1012 configured to measure the measurement range of the laser range finder. As described above, this is because, since there are cases in which the marker 2 is detected or is not detected depending on the measurement range of the laser range finder in some cases, the position of the marker 2 in the height direction can be specified by repeatedly detecting the marker 2 several times.

On the other hand, since lengths of poles made of a metal, cylindrical pillars of the commodity shelf 5, and the like in the height direction and which are present in the environment described above are longer than that of the marker 2, the lengths thereof are easily detected using the laser range finder at all times regardless of fluctuation of the measurement range of the laser range finder. The marker 2 is detected only when the measurement range of the laser range finder has a certain range of angles. Thus, the self-location estimation apparatus 10 can determine the marker 2 and an object with a considerable height (with high reflectance) such as poles made of a metal, cylindrical pillars of the commodity shelf 5, and the like which are not the marker 2 on the basis of whether the object is an object measured at all times each time the object is measured.

A functional constitution of the mobile robot 1 will be described below with reference to the drawings.

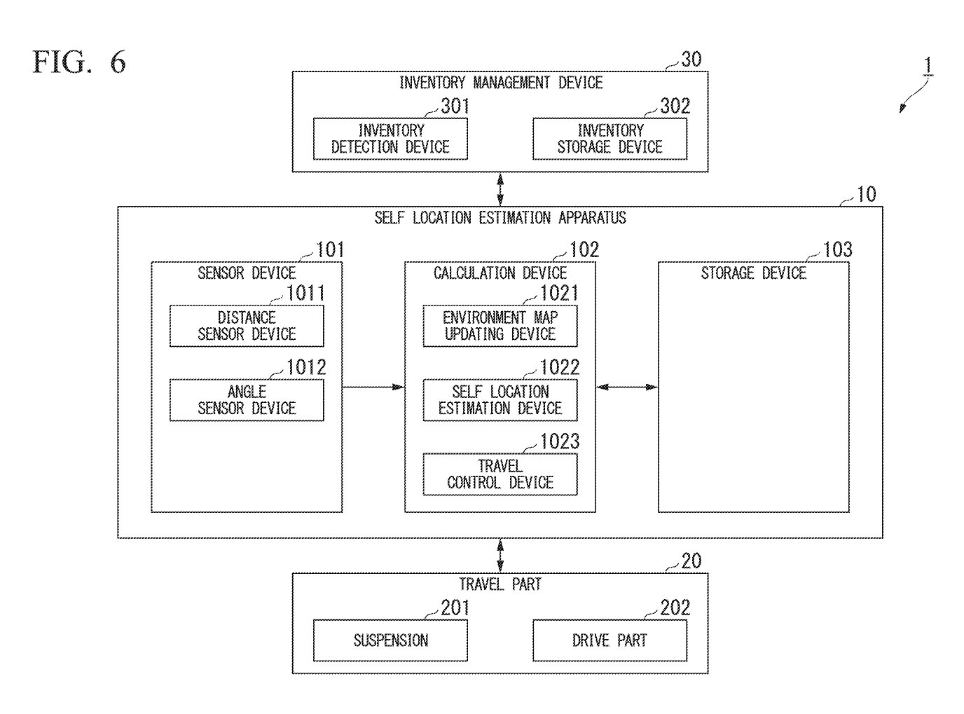

FIG. 6 is a block diagram showing a functional constitution of the mobile robot according to the first embodiment. As shown in FIG. 6, the mobile robot 1 is constituted to include the self-location estimation apparatus 10, a travel part 20, and the inventory management device 30.

The self-location estimation apparatus 10 is constituted to include the sensor device 101, a calculation device 102, and a storage device 103. The self-location estimation apparatus 10 is a device installed at the mobile robot 1 (a cart) moving in an environment on the basis of a travel route set in an environment map.

The sensor device 101 is constituted to include the distance sensor device 1011 and the angle sensor device 1012. Note that the markers 2 detected by the sensor device 101 are mainly installed at the lower portions of the commodity shelves 5 as shown in FIG. 1. For this reason, it is desirable that the sensor device 101 is installed at a lower portion of the mobile robot 1 at a height which is close to a height at which the markers 2 are installed to easily detect the markers 2.

The distance sensor device 1011 measures a distance between a position of its own mobile robot 1 and a position of an object which is present in an environment and intensity of reflected light when a beam (for example, a laser) radiated by the distance sensor device 1011 is reflected by the object. The distance sensor device 1011 is constituted to include a member which can measure a distance between a position of the member from its own mobile robot 1 and an object near the member, for example, a laser range finder.

The angle sensor device 1012 fluctuates due to rocking of the mobile robot 1 along with movement of the mobile robot 1 (the cart), and measures a measurement range of the laser range finder in the distance sensor device 1011. The angle sensor device 1012 is constituted to include a member which can measure an angle, for example, a three-axis acceleration sensor and a three-axis angular acceleration sensor. Note that, as described above, a member constituting the angle sensor device 1012 may be any member as long as the member can measure the angle.

The calculation device 102 is constituted to include an environment map updating device 1021, a self-location estimation device 1022, and a travel control device 1023.

The environment map updating device 1021 generates an environment map on the basis of information indicating a surrounding environment (a distance between the distance sensor device 1011 and an object near the distance sensor device 1011 and the like) measured by the distance sensor device 1011 and information indicating a height of the object near the distance sensor device 1011 based on a measurement range of the distance sensor device 1011 measured by the angle sensor device 1012, and stores the environment map in the storage device 103, which will be described below. Furthermore, the environment map updating device 1021 updates the environment map stored in the storage device 103 each time the sensor device 101 measures the surrounding environment.

The self-location estimation device 1022 estimates a position of its own mobile robot 1 on the basis of a position of the marker 2 (a mark) installed in the environment, which is determined on the basis of the environment map generated and updated by the environment map updating device 1021, the distance measured by the distance sensor device 1011, the intensity of reflected light measured by the distance sensor device 1011, and the measurement range of the distance sensor device 1011 measured by the angle sensor device 1012.

The travel control device 1023 decides a moving direction (a travel route) such that its own mobile robot 1 travels along the travel route registered in the environment map, and controls a drive part 202 in the travel part 20, which will be described below, on the decided travel route. The travel route is decided on the basis of the position of its own mobile robot 1 estimated by the self-location estimation device 1022 and the environment map stored in the storage device 103.

The storage device 103 stores an environment map in an environment generated and updated by the environment map updating device 1021. Furthermore, the storage device 103 stores various programs and pieces of data used in the self-location estimation apparatus 10. The storage device 103 is constituted of; for example, a storage medium, such as a hard disk drive (HDD), a flash memory, an electrically erasable programmable read only memory (EEPROM), a random access read/write memory (RAM; a readable and writable memory), a read only memory (ROM), or any combination of such storage media.

The travel part 20 has a drive function of moving its own mobile robot 1. The travel part 20 is constituted to include the suspension 201 and the drive part 202.

The suspension 201 functions as a shock absorbing device configured to absorb shock when its own mobile robot 1 travels over a step on a floor surface, a laid cable, or the like in an environment. Furthermore, the suspension 201 functions as a device configured to bring drive wheels into contact with a floor surface such that its own mobile robot 1 is not put into a state in which the drive wheels (not shown) are lifted and thus the mobile robot 1 cannot travel when the mobile robot 1 travels over a step, a cable, or the like.

The drive part 202 moves its own mobile robot 1 in accordance with control by the travel control device 1023. The drive part 202 is constituted to include, for example, a drive device, such as a motor, an engine, or the like, and drive wheels (not shown).

The inventory management device 30 checks inventory of the commodities 6 stored in the commodity shelves 5 in an environment and stores inventory information indicating the inventory. The inventory management device 30 is constituted to include the inventory detection device 301 and an inventory storage device 302.

Note that, when shelf inventory management is performed in a store, heights of the commodity shelves 5 are high and stored position of the commodities 6 to which wireless tags are stuck are high in many cases as described above. For this reason, it is desirable that the inventory management device 30 is installed at an upper portion of the mobile robot 1 to easily detect the wireless tags.

The inventory detection device 301 is constituted to include a wireless tag reader (not shown). The inventory detection device 301 detects the wireless tags (not shown) stuck to the commodities 6 when the mobile robot 1 travels in front of each of the commodity shelves 5. Moreover, the inventory detection device 301 generates inventory information of the commodities 6 on the basis of the fact that the wireless tags are detected or information indicated by radio waves received from the wireless tags, and stores the generated inventory information in the inventory storage device 302, which will be described below.

Note that, as described above, a means for checking inventory is not limited to the above-described means. In the case of the means for checking the inventory, for example, the inventory management device 30 may be constituted to image the commodity shelves 5 using a camera (not shown) included in the inventory management device 30 and to analyze the captured image to check the inventory.

The inventory storage device 302 stores the inventory information generated by the inventory detection device 301. The inventory storage device 302 is constituted of, for example, a storage medium, such as an HDD, a flash memory, an EEPROM, a RAM, a ROM, or any combination of such storage media.

An operation when the self-location estimation apparatus 10 determines the marker 2 will be described below with reference to the drawings.

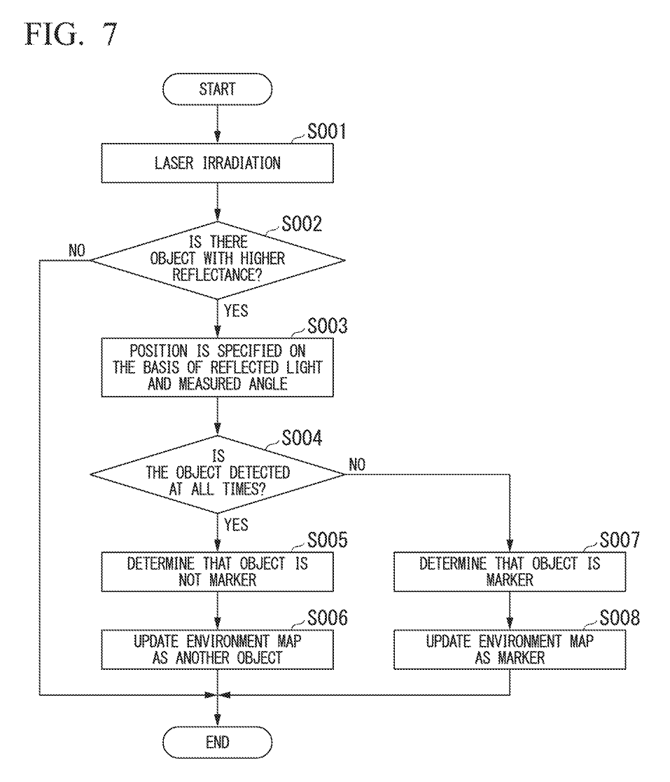

FIG. 7 is a flowchart for describing an operation of the self-location estimation apparatus of the mobile robot according to the first embodiment. This flowchart starts when the distance sensor device 1011 measures a distance between its own mobile robot 1 and an object near the mobile robot 1.

(Step S001) A laser range finder in the distance sensor device 1011 irradiates the object near the mobile robot 1 with a laser. Subsequently, a process proceeds to a process of Step S002.

(Step S002) The laser range finder in the distance sensor device 1011 receives reflected light of the irradiated laser and detects the object near the mobile robot 1. Furthermore, the distance sensor device 1011 detects whether there is an object with reflectance higher than those of other objects near the mobile robot 1 on the basis of reflection intensity of the reflected light. When it is determined that there is an object with higher reflectance, the process proceeds to a process of Step S003. When it is determined that there is no object with higher reflectance, the process of this flowchart ends.

(Step S003) The angle sensor device 1012 measures a measurement range of the laser range finder in the distance sensor device 1011. Moreover, the environment map updating device 1021 specifies a position including a height direction of the object with higher reflectance on the basis of a distance between the laser range finder and the object measured by the laser range finder on the basis of the reflected light and the measurement range of the laser range finder. Subsequently, the process proceeds to a process of Step S004.

(Step S004) The environment map updating device 1021 refers to an environment map stored in the storage device 103 and determines whether the object with higher reflectance which is present at a specified position in Step S003 is an object detected at all times when a surrounding environment was previously measured. When it is determined that the object with higher reflectance is an object detected at all times, the process proceeds to a process of Step S005. When it is determined that the object with higher reflectance is not an object detected at all times, the process proceeds to a process of Step S007.

(Step S005) The environment map updating device 1021 determines that the object with higher reflectance detected in Step S002 is not the marker 2 (for example, is another object with high reflectance such as a metal pole). Subsequently, the process proceeds to a process of Step S006.

(Step S006) The environment map updating device 1021 updates the environment map stored in the storage device 103 using the object with higher reflectance as another object other than the marker 2 on the basis of the position of the object with higher reflectance measured in Step S003.

Here, the process of this flowchart ends.

(Step S007) The environment map updating device 1021 determines that the object with higher reflectance detected in Step S002 is the marker 2. Subsequently, the process proceeds to a process of Step S008.

(Step S008) The environment map updating device 1021 updates the environment map stored in the storage device 103 using the object with higher reflectance as the marker 2 on the basis of the position of the object with higher reflectance (including information associated with a considerable height of the object) measured in Step S003.

Here, the process of this flowchart ends.

Here, when the mobile robot 1 travels over a step and an obstacle on a floor surface in the environment as described above in the first embodiment, the mobile robot 1 rocks due to the suspension 201 so that the measurement range of the laser range finder in the distance sensor device 1011 fluctuates each time the surrounding environment is measured. In the self-location estimation apparatus 10 according to the first embodiment, estimation accuracy of a self-location is improved using the fluctuation of the measurement range of the laser range finder.

When the detected object with high reflectance is an object detected at all times regardless of the measurement range of the laser range finder, the self-location estimation apparatus 10 can recognize that the object is an object with a considerable height (for example, a metal pole and the like). Furthermore, when the detected object with high reflectance is an object which is not detected depending on the measurement range of the laser range finder, the self-location estimation apparatus 10 can recognize that the object is an object with a short length in the height direction. Moreover, the self-location estimation apparatus 10 determines that the object is the marker 2 on the basis of the fact that the object has higher reflectance than surrounding objects.

Thus, the self-location estimation apparatus 10 can decrease a determination error concerning whether the detected object is an object (the marker 2) installed for the purpose of estimating a self-location, and can more accurately estimate a self-location to improve accuracy of the environment map.

### Second Embodiment

A second embodiment will be described below with reference to the drawings. Note that a description of a range of the second embodiment which has the same constitution as the first embodiment will be omitted.

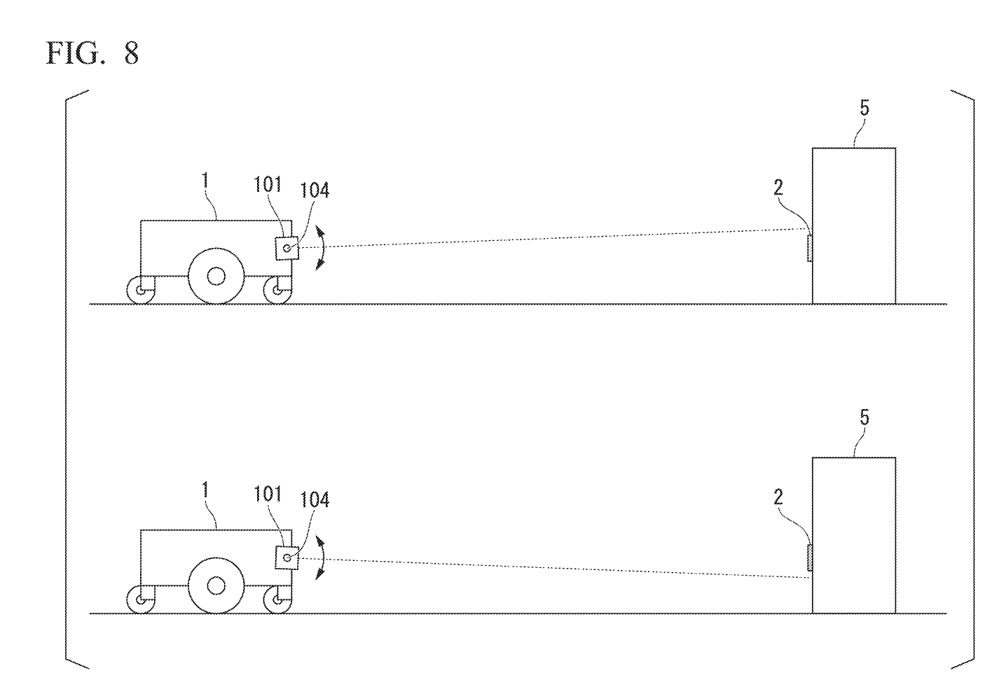

FIG. 8 is a diagram illustrating an example detecting a marker using a mobile robot according to the second embodiment. A mobile robot 1 according to the second embodiment includes a rocking part 104 configured to vertically rock a sensor device 101. The rocking part 104 is constituted to include, for example, a vibration element such as a rotating shaft or a spring. The sensor device 101 is attached to the mobile robot 1 via the rocking part 104.

Thus, in the second embodiment, when the mobile robot 1 travels over a step and an obstacle on a floor surface in an environment, the sensor device 101 is rocked by the rocking part 104, and a measurement range of a laser range finder in a distance sensor device 1011 fluctuates for each measurement of surrounding environment. In a self-location estimation apparatus 10 according to the second embodiment, estimation accuracy of a self-location is improved using the fluctuation of the measurement range of the laser range finder.

When a detected object with high reflectance is an object detected at all times regardless of a detectable of the laser range finder, the self-location estimation apparatus 10 can recognize that the object is an object with a considerable height (for example, a metal pole and the like). Furthermore, when the detected object with high reflectance is an object which is not detected depending on the detectable of the laser range finder, the self-location estimation apparatus 10 can recognize that the object is an object with a short length in a height direction. Moreover, the self-location estimation apparatus 10 can determine that the object is the marker 2 on the basis of the fact that the object has higher reflectance than surrounding objects and is an object which is not detected depending on the measurement range of the laser range finder.

Thus, the self-location estimation apparatus 10 can decrease a determination error concerning whether the detected object is an object (the marker 2) installed for the purpose of estimating a self-location, and can more accurately estimate a self-location to improve accuracy of an environment map.

### Third Embodiment

A third embodiment will be described below with reference to the drawing. Note that a description of a range of the third embodiment which has the same constitution as the first embodiment will be omitted.

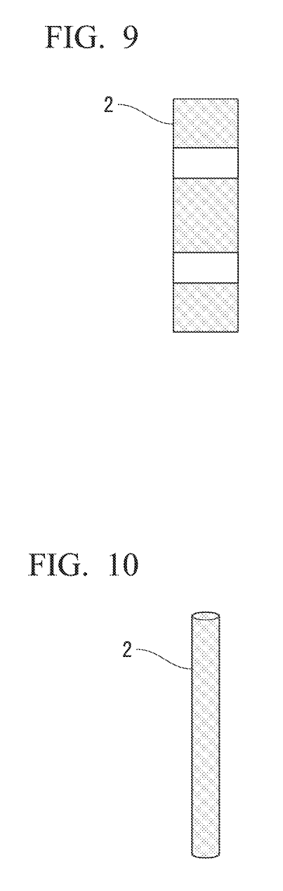

FIG. 9 is a diagram illustrating an example of a marker detected by a mobile robot according to the third embodiment.

As shown in FIG. 9, in the third embodiment, retroreflection member portions of a marker 2 are arranged in a horizontal strip shape. Moreover, widths and the number of strips serving as the retroreflection member portions differ for each marker 2.

Note that the marker 2 illustrated in FIG. 9 is a marker in which portions shaded in gray are the retroreflection member portions, and three retroreflection members are arranged in the horizontal strip shape.

Note that the marker 2 having a horizontal strip shape may be obtained by arranging a plurality of strip-shaped retroreflection members in parallel in a horizontal direction, and may be formed such that the retroreflection members which are exposed have the horizontal strip shape by sticking a member made of a material with low reflectance and which has a strip shape to one retroreflection member.

Also, a calculation device 102 in a self-location estimation apparatus 10 according to the third embodiment includes a mark identification part (not shown) configured to identify the marker 2 (marks) on the basis of the widths of the retroreflection member portions (the marks) of the marker 2 or the number of strips of the retroreflection member portion (the marks) of the marker 2 installed in the horizontal strip shape.

The self-location estimation apparatus 10 detects the marker 2 using a sensor device 101 and specifies an identifier corresponding to the detected marker 2 using the mark identification part. A mark detection part specifies the identifier corresponding to the marker 2 on the basis of the number and widths of horizontal strips of the detected marker 2. Moreover, the environment map updating device 1021 registers the identifier corresponding to the marker 2 identified using the mark identification part in an environment map stored in a storage device 103 together with location information of the marker 2.

Thus, since a self-location estimation device 1022 can collate the identifier corresponding to the marker 2 detected by the sensor device 101 and the identifier corresponding to the marker 2 registered in the environment map, the self-location estimation device 1022 can more accurately identify the marker 2. The self-location 15 estimation apparatus 10 can more accurately identify the marker 2, and thus can more accurately estimate a self-location.

### Fourth Embodiment

A fourth embodiment will be described below with reference to the drawing. Note that a description of a range of the fourth embodiment which has the same constitution as the first embodiment will be omitted.

FIG. 10 is a diagram illustrating an example of a marker detected by a mobile robot according to the fourth embodiment. As shown in FIG. 10, in the fourth embodiment, a retroreflection member of a marker 2 is installed in a curved surface shape to be wound around a cylindrical object (for example, a pillar of a commodity shelf 5 or the like).

Thus, the marker 2 is more easily detected because the marker 2 can be detected from every angle in the measurement range by the laser range finder of the distance sensor device 1011. Since the marker 2 is more easily detected so that accuracy of an environment map is improved, a self-location estimation apparatus 10 can more accurately estimate a self-location.

### Fifth Embodiment

A fifth embodiment will be described below with reference to the drawing. Note that a description of a range of the fifth embodiment which has the same constitution as the first embodiment will be omitted.

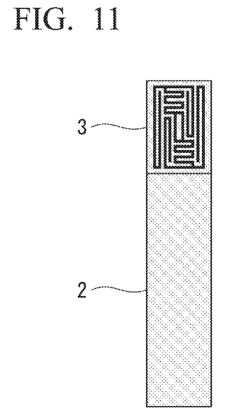

FIG. 11 is a diagram illustrating an example of a marker detected by a mobile robot according to the fifth embodiment. As shown in FIG. 11, in the fifth embodiment, wireless tags 3 are installed near markers 2. Note that each of the markers 2 and each of the wireless tags 3 need not necessarily be installed adjacent to each other like in FIG. 11, and may be set to be separated from each other as long as the marker 2 and the wireless tag 3 are installed to be adjacent to each other.

Also, a sensor device 101 in a self-location estimation apparatus 10 in a mobile robot 1 according to the fifth embodiment includes a wireless tag reader device (not shown). The wireless tag reader device is constituted to include a wireless tag reader which can receive radio waves transmitted from the wireless tag 3 installed near the marker 2 (a mark) installed in an environment to detect and identify the wireless tag 3.

Note that the present invention may be constituted such that the wireless tag 3 is not detected using the wireless tag reader device included in the sensor device 101 in the self-location estimation apparatus 10 as described above, and an inventory detection device 301 detects the wireless tag 3 using the above-described wireless tag reader constituting the inventory detection device 301 of an inventory management device 30.

Note that the wireless tag reader includes, for example, two types of antennas (not shown), i.e., an antenna configured to generate a magnetic field used to cause the wireless tags 3, which serve as passive type wireless tags, to transmit radio waves and an antenna configured to receive data (for example, an identifier used to identify the wireless tags 3 or the marker 2 and the like) from the wireless tags 3. The passive type wireless tag is a wireless tag of a type which has no battery built therein, which is driven using electromagnetic induction or the like induced due to a magnetic field generated by the wireless tag reader, and in which radio waves are received and transmitted.

In the mobile robot 1 according to the fifth embodiment, the wireless tag reader attempts to detect radio waves transmitted by the wireless tag 3 installed near the marker 2 if a laser range finder in a distance sensor device 1011 detects an object with high reflectance when the mobile robot 1 travels along a travel route based on an environment map. When the radio waves transmitted by the wireless tag 3 installed near the marker 2 are detected, an environment map updating device 1021 determines that the object with high reflectance detected as described above is the marker 2. Moreover, the environment map updating device 1021 updates the environment map stored in the storage device 103 on the basis of location information of the marker 2 measured by the distance sensor device 1011 and the identifier used to identify the detected wireless tag 3.

Thus, the self-location estimation apparatus 10 according to the fifth embodiment can more accurately identify the marker 2 and another object with high reflectance such as a metal pole.

Note that identifiers used to identify wireless tags 3 installed in an environment and location information of the wireless tags 3 are linked, and the linkages may be registered in the environment map in advance. Thus, the self-location estimation apparatus 10 can more accurately collate the wireless tags 3 and the marker 2 registered in the environment map and the wireless tags 3 and the marker 2 detected using the sensor device 101. Therefore, since accuracy of detection and identification of the marker 2 is further increased using the self-location estimation apparatus 10, estimation accuracy of a position of its own mobile robot 1 is further improved.

An operation when the self-location estimation apparatus 10 determines whether an object is the marker 2 will be described below with reference to the drawings.

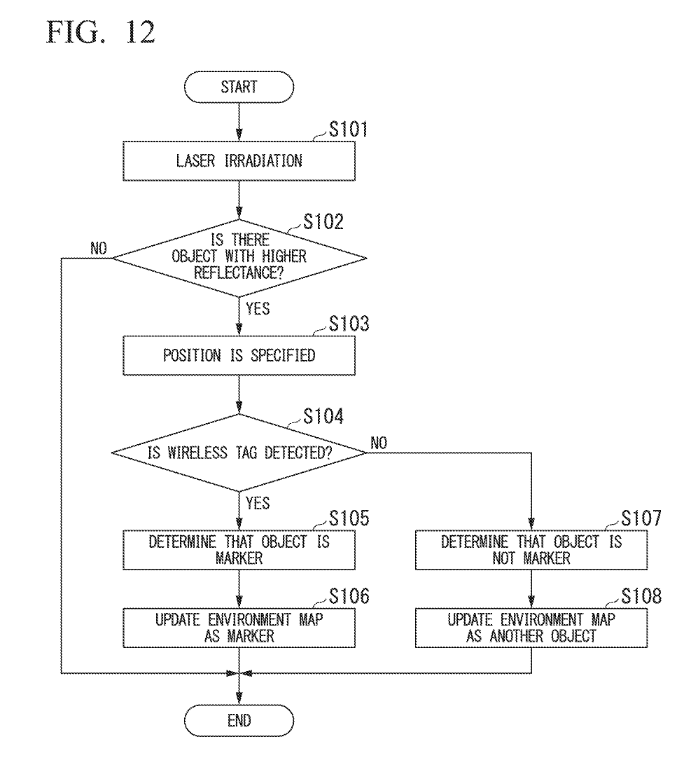

FIG. 12 is a flowchart for describing the operation of the self-location estimation apparatus of the mobile robot according to the fifth embodiment. A process of this flowchart starts when the distance sensor device 1011 measures a distance between the distance sensor device 1011 and an object near the distance sensor device 1011.

(Step S101) The laser range finder in the distance sensor device 1011 irradiates objects near the laser range finder with a laser. Subsequently, the process proceeds to a process of Step S102.

(Step S102) The laser range finder in the distance sensor device 1011 detects the objects near the laser range finder by receiving reflected light of the irradiated laser. Furthermore, the distance sensor device 1011 detects whether there is an object with reflectance higher than that of other surrounding objects on the basis of reflection intensity of the reflected light. When it is determined that there is an object with higher reflectance, the process proceeds to a process of Step S103. When it is determined that there is no object with higher reflectance, the process of this flowchart ends.

(Step S103) The environment map updating device 1021 specifies a position of the object with higher reflectance on the basis of a distance thereof from the object measured by the laser range finder on the basis of the reflected light. Subsequently, the process proceeds to a process of Step S104.

(Step S104) The wireless tag reader device attempts to detect radio waves transmitted by the wireless tag 3 installed near the marker 2. When the radio waves are detected, the environment map updating device 1021 recognizes an identifier of the wireless tag 3 serving as information included in the detected radio waves, and the process proceeds to a process of Step S105. When the radio waves are not detected, the process proceeds to a process of Step S107.

(Step S105) The environment map updating device 1021 determines that the object with higher reflectance detected in Step S102 is the marker 2. Subsequently, the process proceeds to a process of Step S106.

(Step S106) The environment map updating device 1021 updates an environment map stored in the storage device 103 using the object with higher reflectance as the marker 2 on the basis of the position of the object with higher reflectance measured in Step S103.

Note that location information of the marker 2 and the identifier of the wireless tag 3 recognized by the environment map updating device 1021 in Step S104 are associated with each other, and the association is registered in the environment map.

Here, the process of this flowchart ends.

(Step S107) The environment map updating device 1021 determines that the object with higher reflectance detected in Step S102 is not the marker 2 (is, for example, another object with high reflectance such as a metal pole). Subsequently, the process proceeds to a process of Step S108.

(Step S108) The environment map updating device 1021 updates the environment map stored in the storage device 103 using the object with higher reflectance as the other object which is not the marker 2 on the basis of the position of the object with higher reflectance measured in Step S103.

Here, the process of this flowchart ends.

Although the distance sensor device 1011 can accurately measure a distance thereof from the mobile robot 1 to the marker 2, the distance sensor device 1011 has a disadvantage in that it has difficulty identifying specific details of the detected marker 2. On the other hand, although the wireless tag reader device can identify the specific details of the detected marker 2, the wireless tag reader device has a disadvantage in that it has difficulty accurately measuring the distance thereof from the mobile robot 1 to the marker 2. According to the above-described fifth embodiment, the disadvantages of the distance sensor device 1011 and the wireless tag reader device can be compensated.

Note that, in the mobile robot 1 according to the fifth embodiment, the angle sensor device 1012 shown in FIG. 6 is not necessarily a necessary constitution.

### Sixth Embodiment

The above-described self-location estimation apparatus according to the first to fifth embodiments are devices mounted in a mobile robot mainly used in a store, but a self-location estimation apparatus in a mobile robot according to a sixth embodiment, which will be described below, is a device mounted in a mobile robot configured to perform a device inspection of a plant or the like installed outdoors.

The sixth embodiment will be described below with reference to the drawings. Note that a description of a range of the sixth embodiment which has the same constitution as the first embodiment will be omitted.

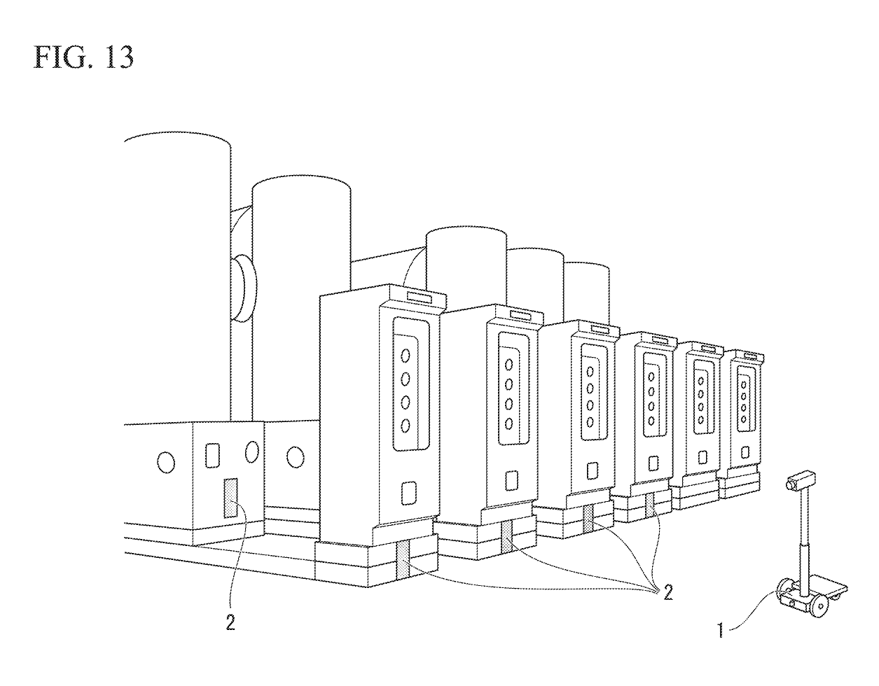

FIG. 13 is a diagram showing an overview of a device inspection using the mobile robot according to the sixth embodiment.

Since a travel surface of a mobile robot 1 is a road constructed by, for example, gravel, asphalt, and the like in an outdoor plant, the travel surfaice has unevenness compared with an indoor floor surface inside a factory and the like. For this reason, a measurement range of a laser range finder mounted in the mobile robot 1 traveling in the outdoor plant significantly fluctuates in comparison to that of an indoor floor surface. Therefore, it is more difficult to improve estimation accuracy of a self-location.

Also, there are relatively fewer objects with considerable heights, such as commodity shelves, pillars, and walls in a store, in the outdoor plant in many cases. Furthermore, places to be inspected through a device inspection (for example, a meter used to examine and the like) are not moved or removed like commodities 6 stored in commodity shelve 5 in the store, and are present at a predetermined position at all times. For this reason, the mobile robot 1 may be used as long as the mobile robot 1 can move near the place to be inspected through the device inspection, and very high accuracy for travel along a travel route to such a place is not required in many cases.

In the sixth embodiment, a marker 2 is installed near the place to be inspected through the device inspection (for example, a meter used to examine and the like). Moreover, a self-location estimation apparatus 10 detects the marker 2 using a laser range finder and registers the detected marker 2 in an environment map. The mobile robot 1 travels along a travel route based on the environment map, and moves near the place to be inspected through the device inspection. Thus, since an environment map updating device 1021 may be used as long as the environment map updating device 1021 registers only location information of the marker 2 installed near the place to be inspected through the device inspection in the sixth embodiment, the mobile robot 1 can more easily estimate a self-location, move near such a place, and perform the device inspection.

According to at least one of the above-described embodiments, the self-location estimation apparatus 10 includes the angle sensor device 1012 configured to measure the measurement range of the laser range finder in the distance sensor device 1011 which fluctuates due to rocking along with movement of the mobile robot 1 (the cart), decrease a determination error concerning whether the detected object is an object installed for the purpose of estimating the self-location, and thus can more accurately estimate a self-location.

Note that all or a part of the self-location estimation apparatus 10 according to the above-described embodiments may be realized using a computer. In this case, a program configured to realize control functions may be recorded in a computer-readable recording medium, and the program recorded in the recording medium may be read in a computer system so that the control functions are realized by the program being executed.

Note that a “computer system” mentioned herein is a computer system mounted in the self-location estimation apparatus 10, which includes an operating system (OS) and hardware such as peripheral devices. Furthermore, a “computer-readable recording medium” refers to a portable medium such as a flexible disk, a magneto optical disk, a read only memory (ROM), a compact disc (CD)-ROM, and a storage device such as a hard disk mounted in the computer system.

In addition, the “computer-readable recording medium” may include a medium configured to dynamically hold a program for a short time like a communication circuit when the program is transmitted over a network such as the Internet or the communication circuit such a telephone circuit, and a medium configured to hold the program for a certain period of time like a volatile memory inside a computer system serving as a server and a client in this case. Furthermore, the above-described program may be a program configured to realize a part of the above-described functions, and may be a program which can realize the above-described function using a combination of the program and a program recorded in the computer system in advance.

All or a part of the self-location estimation apparatus 10 according to the above-described embodiments may be realized as an integrated circuit such as a large scale integration (LSI). Functional blocks of the self-location estimation apparatus 10 may be individually implemented as processors, and all or a part thereof may be integrated and implemented as processors. Furthermore, a method of implementing an integrated circuit is not limited to an LSI, and may be implemented using a dedicated circuit or a general purpose processor. When technology for implementing an integrated circuit to replace an LSI emerges due to advances in semiconductor technology, an integrated circuit using such technology may be used.

While preferred embodiments of the invention have been described and illustrated above, it should be understood that these embodiments are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A self-location estimation apparatus installable at a cart which is movable on the basis of an environment map, the self-location estimation apparatus comprising:
a distance sensor device configured to measure a distance thereof from an object;
an angle sensor device configured to measure a measurement range of the distance sensor device, which fluctuates due to rocking along with movement of the cart; and
an estimation device configured to estimate a self-location on the basis of a position of a mark installed on the object and which is identified using the environment map, the distance, and the measurement range.

2. A self-location estimation apparatus installable at a cart which is movable on the basis of an environment map, the self-location estimation apparatus comprising:
a distance sensor device configured to measure a distance thereof from an object;
a wireless tag reader device configured to detect a wireless tag installed near a mark installed on the object; and
an estimation device configured to estimate a self-location on the basis of a position of the mark identified using the environment map and the distance, and the wireless tag.

3. The self-location estimation apparatus according to claim 1, wherein the distance sensor device measures intensity of reflected light from the object, and
the estimation device estimates the self-location on the basis of a position of the mark identified using the intensity of the reflected light.

4. The self-location estimation apparatus according to claim 2, wherein the distance sensor device measures intensity of reflected light from the object, and
the estimation device estimates the self-location on the basis of a position of the mark identified using the intensity of the reflected light.

5. The self-location estimation apparatus according to claim 1, comprising:
a wireless tag reader device configured to detect a wireless tag installed near the mark,
wherein the estimation device estimates the self-location on the basis of the wireless tag.

6. The self-location estimation apparatus according to claim 1, comprising:
a rocking part configured to rock the distance sensor device in accordance with the rocking along with the movement of the cart.

7. The self-location estimation apparatus according to claim 2, comprising:
a rocking part configured to rock the distance sensor device in accordance with the rocking along with the movement of the cart.

8. The self-location estimation apparatus according to claim 1, comprising:
a mark identification part configured to identify the mark on the basis of a width of the mark or the number of strips of a mark installed in a horizontal strip shape.

9. The self-location estimation apparatus according to claim 2, comprising:
a mark identification part configured to identify the mark on the basis of a width of the mark or the number of strips of a mark installed in a horizontal strip shape.

10. The self-location estimation apparatus according to claim 1, wherein the estimation device estimates the self-location on the basis of a position of a mark of a curved surface shape.

11. The self-location estimation apparatus according to claim 2, wherein the estimation device estimates the self-location on the basis of a position of a mark of a curved surface shape.

12. The self-location estimation apparatus according to claim 1, comprising:
a storage device configured to store the environment map.

13. The self-location estimation apparatus according to claim 2, comprising:
a storage device configured to store the environment map.

14. A self-location estimation method using a computer of a self-location estimation apparatus installable at a cart which is movable on the basis of an environment map, the self-location estimation method comprising:
a distance sensor step of measuring, by a distance sensor device, a distance thereof from an object;
an angle sensor step of measuring, by an angle sensor device, a measurement range of the distance sensor device, which fluctuates due to rocking along with the movement of the cart; and
an estimation step of estimating, by an estimation device, a self-location on the basis of a position of a mark installed on the object, which is identified using the environment map, the distance, and the measurement range.

15. A self-location estimation method using a computer of a self-location estimation apparatus installable at a cart which is movable on the basis of an environment map, the self-location estimation method, comprising:
a distance sensor step of measuring, by a distance sensor device, a distance thereof from an object;
a wireless tag reader step of detecting, by a wireless tag reader device, a wireless tag installed near a mark installed on the object; and
an estimation step of estimating, by an estimation device, a self-location on the basis of a position of the mark identified using the environment map and the distance, and the wireless tag.
